(19) United States
(12) Patent Application Publication
(10) Pub. No.: US 2006/0259408 A1
(43) Pub. Date: Nov. 16, 2006

(54) Method and system for facilitating purchasing of advertising via electronic auction

(76) Inventors: Douglas A. Levy, Dallas, TX (US); Marc Blumberg, Dallas, TX (US); Stephen Paul Minichini, Norwalk, CT (US)

Correspondence Address: Daniel H. Golub, 1701 Market Street, Philadelphia, PA, 19103, US

(21) Appl. No.: 11/417,634

(22) Filed: May 4, 2006

Related U.S. Application Data
(63) Continuation-in-part of application No. 10/894,252, filed on Jul. 19, 2004.
(60) Provisional application No. 60/492,387, filed on Aug. 4, 2003.

(51) Int. Cl. G06Q 40/00

(52) U.S. Cl. 705/37

(57) ABSTRACT

Purchasing of advertising is facilitated via an electronic auction. A purchase price is set, and includes an amount that an advertising purchaser is willing to pay for advertising. Advertising sellers are informed of the purchase price. The electronic auction is conducted via a website interface maintained on a computer network. Bids posted by the advertising sellers are received. The bids include a quantity of advertising the advertising seller is willing to provide in exchange for the purchase price. A winning bid is identified based at least in part on the quantity of advertising each of the advertising sellers is willing to provide.

### CROSS REFERENCE TO RELATED APPLICATIONS

This application is a continuation-in-part of U.S. patent application Ser. No. 10/894,252, filed Jul. 19, 2004, and entitled “Method for Facilitating Purchasing of Advertising via Electronic Auction”, which claims priority to U.S. Provisional Patent Application No. 60/492,387, filed Aug. 4, 2003, and entitled “Method for Securing Online Media Campaigns”, which are hereby incorporated by reference in their entirety.

### BACKGROUND OF THE INVENTION

1. Field of the Invention

The present invention relates to methods and systems for purchasing advertising and, in particular, methods for ensuring competitive bidding for purchase of advertising by bringing together media vendors in a way that enhances the value of media buys for advertisers.

2. Background

The media marketplace is vast, diverse and complex. With hundreds of vendors offering millions of advertising impressions every day, the sheer volume of unique marketing opportunities if staggering. Couple this with the ever-increasing complexity of media buying and the need for an innovative buying solution has never been more critical. Prior to the present invention, media buyers would issue requests for proposal and review the responses of the media vendors. Upon selecting a vendor, contract negotiations would commence and, depending on the size of the buy, would take several weeks to conclude. Thus, prior art processes for media buying were cumbersome and inefficient. While prior art processes include an electronic means for managing the paperwork associated with the media purchasing process, none of these processes ensure that the advertiser is getting the best deal possible.

### SUMMARY OF THE INVENTION

The present invention is directed to a method and system for facilitating purchasing of advertising via an electronic auction. A purchase price, which includes an amount that an advertising purchaser is willing to pay for advertising, is set. Advertising sellers are informed of the purchase price. The electronic auction is conducted via a website interface maintained on a computer network. The electronic auction is moderated by a moderator which may, in whole or in part, be automated. Bids posted by the advertising sellers are received at the website over the computer network. The bids include a quantity of advertising the advertising seller is willing to provide in exchange for the purchase price. A winning bid is identified based, at least in part, on the quantity of advertising each of the advertising sellers is willing to provide. In one embodiment, in which at least some of the moderator functionality is performed by a live person, the website interface includes at least three display views: a moderator display view, an advertising seller display view, and an advertising purchaser display view. All of the display views include two separate areas, one of the areas including a submitted bid viewing area and one of the areas including a moderator comment area. Upon being posted, all of the bids are viewable in the bid viewing area by all of the advertising sellers, by the advertising purchaser, and by the moderator.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 illustrates an exemplary screen used in connection with managing session details;

FIG. 2 illustrates another exemplary screen used in connection with managing session details;

FIG. 3 illustrates another exemplary screen used in connection with managing session details;

FIG. 4 illustrates another exemplary screen used in connection with managing session details;

FIG. 5 illustrates an exemplary invitation sent to a media vendor;

FIG. 6 illustrates details for an exemplary program that will be the subject of an auction;

FIG. 7 illustrates exemplary criteria that may be reviewed in connection with a media vendor's potential participation in an auction;

FIG. 8A illustrates details for an exemplary program that will be the subject of an auction;

FIG. 8B is a screen shot showing an exemplary page where a participant can view future and past sessions in which it participated;

FIG. 9 is a flow chart illustrating an exemplary auction day process;

FIG. 10 illustrates one embodiment of an exemplary virtual bidding room;

FIG. 11 illustrates an alternative embodiment of one view of an exemplary virtual bidding room;

FIG. 12 illustrates another view of the exemplary virtual bidding room of the alternative embodiment;

FIG. 13 illustrates another view of the virtual bidding room of the alternative embodiment;

FIG. 14 is an exemplary interface for allowing customization of the virtual bidding room;

FIG. 15 illustrates details for an exemplary program that will be the subject of an auction;

FIG. 16 illustrates exemplary results of the auction carried out for the program details illustrated in FIG. 15;

FIG. 17 is a flow chart illustrating a method for facilitating purchasing of advertising via an electronic auction; and

FIG. 18 illustrates an exemplary system for carrying out the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention is directed to a network-based (preferably, Web-based) media negotiation tool that advertisers can use in connection with their media buying efforts. In connection with the invention, advertising is purchased via an on-line auction. The advertising that is to be purchased may include on-line advertising such as, by way of example, the number of impressions, the number of mouse clicks, the number of acquisitions, the number of leads, gross rating points, open rate, and rate card value of advertising offered. The present invention is not limited to on-line advertising, however, and may be used for other types of media, including, by way of example, print, television, out-of-home, radio and combinations thereof. The various methods of advertising, and advertising media, that may be the subject of the on-line auction will be known to those skilled in the art. The invention provides an opportunity for media vendors to sell their properties through a bid-driven, on-line, media buying process. Vendors bid against each other simultaneously, thereby resulting in competition that dramatically increases the amount of media inventory, reduces the time of negotiation between media buyers and media vendors, and creates a more effective overall media buy.

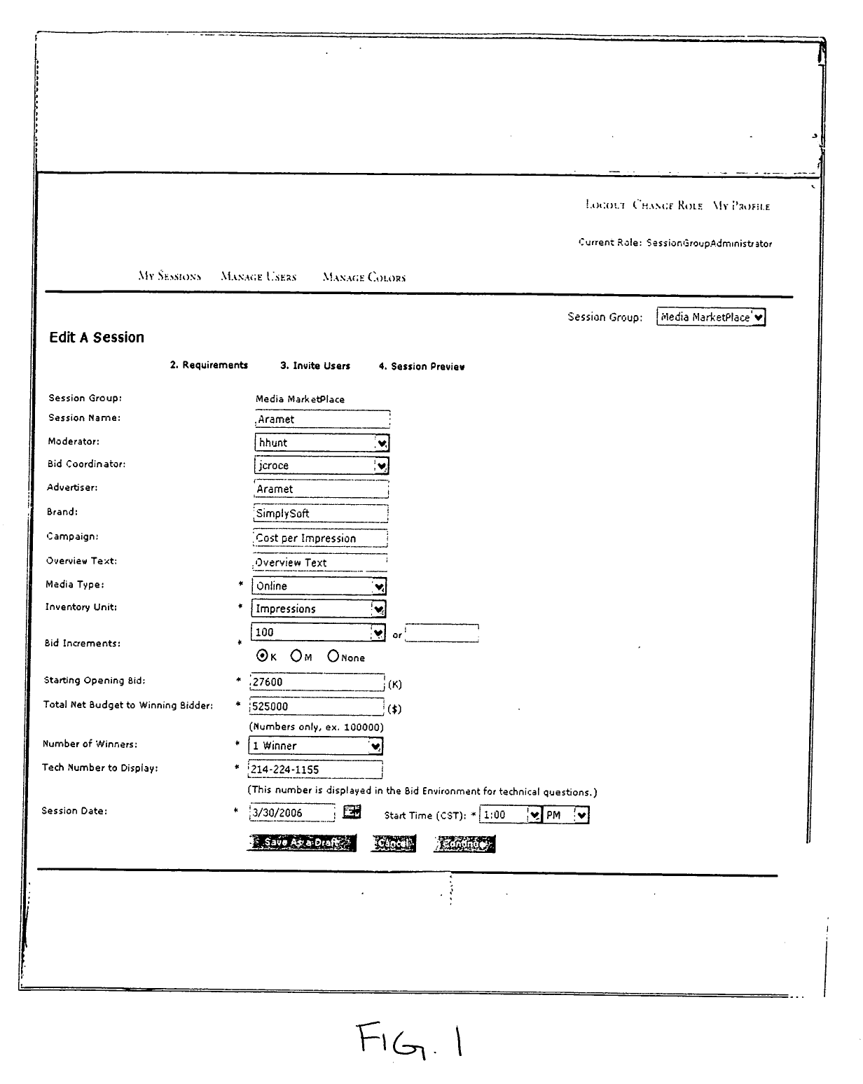

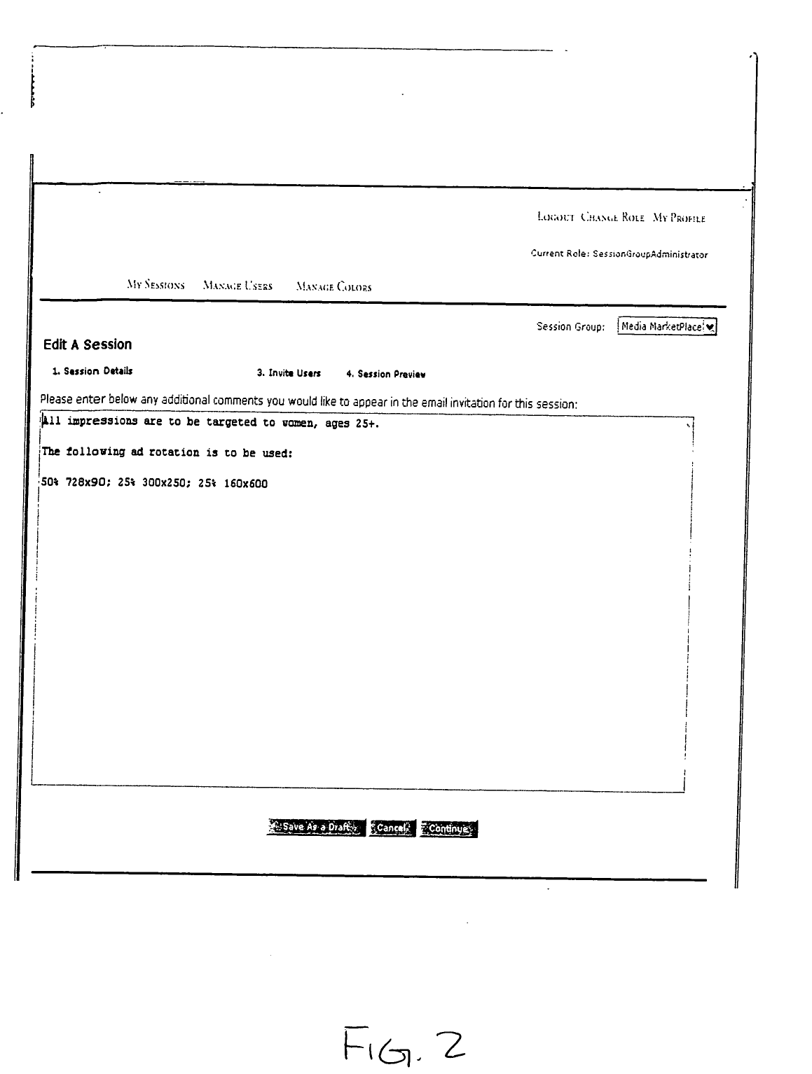

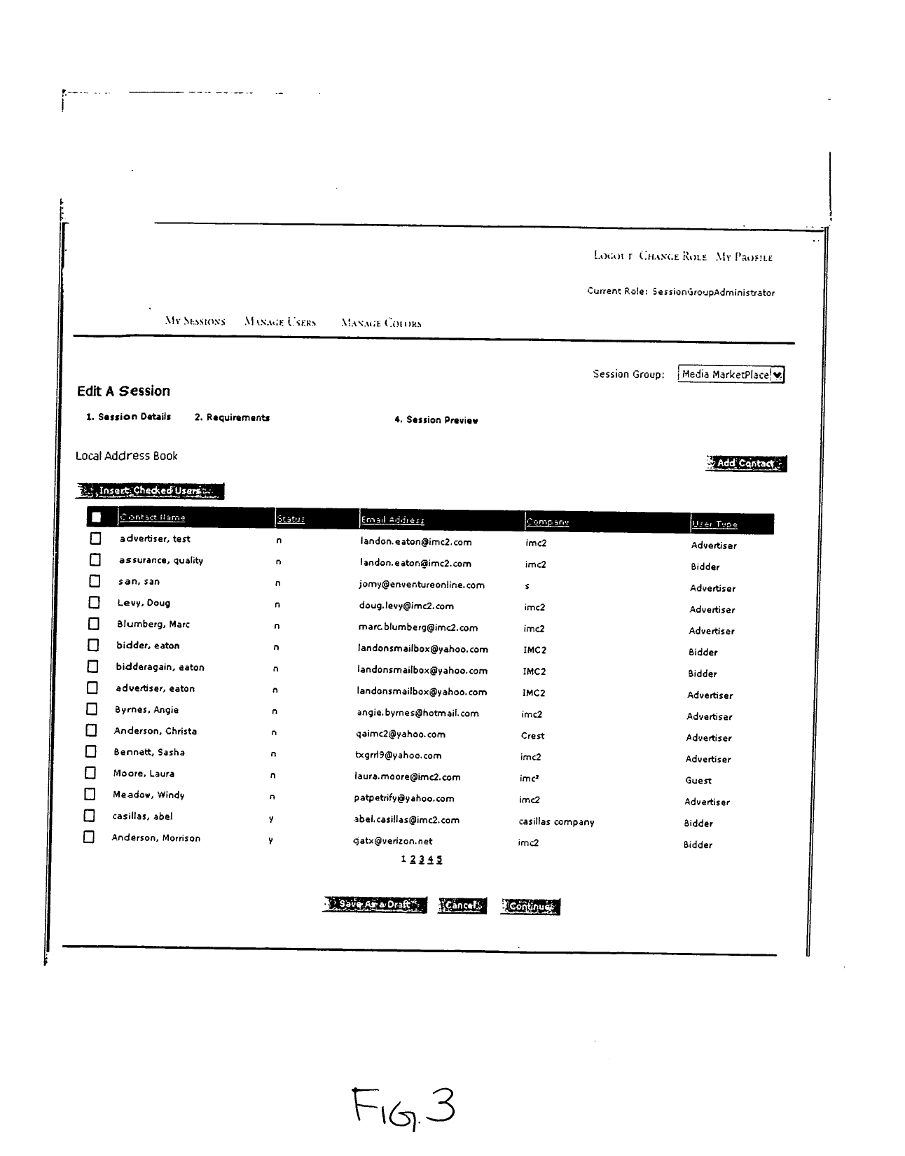

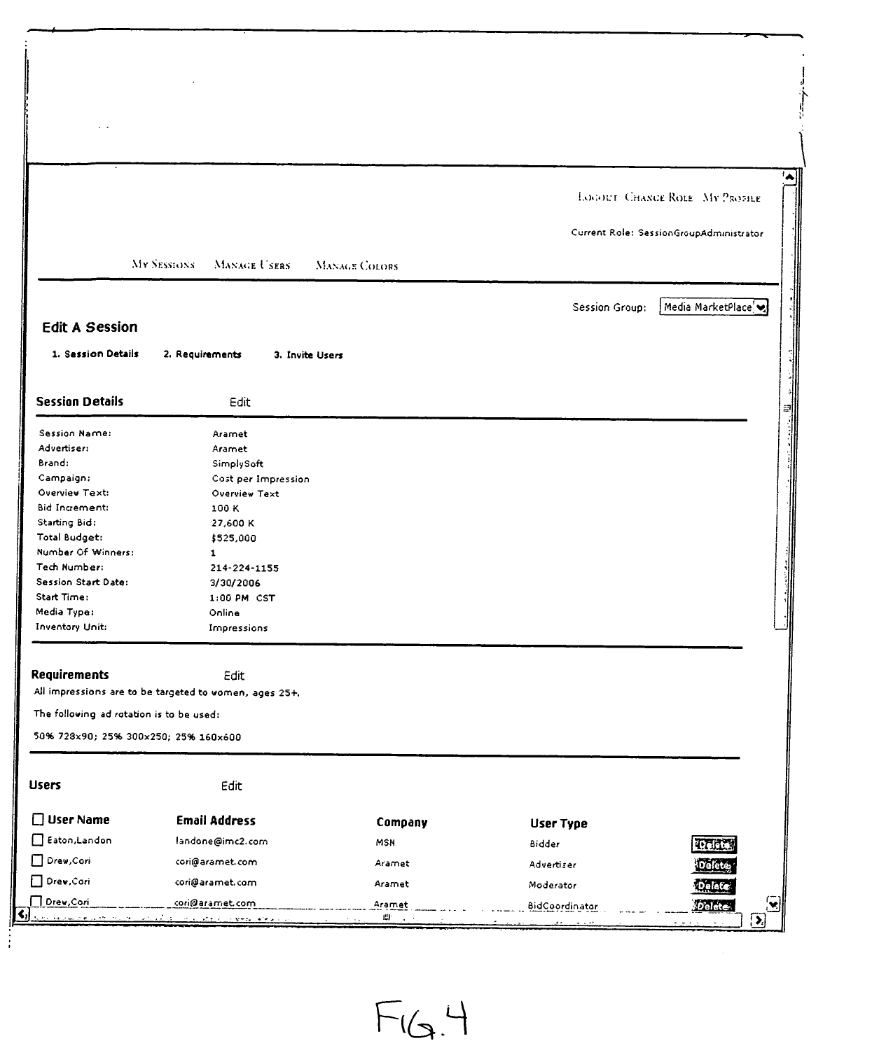

As an initial step, a media buyer defines the media program that will be the subject of the auction, including objectives for the campaign, campaign start and end dates, minimum criteria for campaign success, and a budgetary commitment for the media buy. The information defined by the media buyer may be input into the inventive system and managed by an administrator. FIGS. 1, 2, 3 and 4 show exemplary interfaces that may be used by an administrator in inputting and managing the auction sessions for advertising campaigns of a media buyer. With reference to FIG. 1, the administrator can input details of the session, as indicated by the media buyer. With reference to FIG. 2, the administrator can set forth additional comments the media buyer wants included in the invitation to the media vendors for the session. With reference to FIG. 3, the administrator can indicate participants who should be invited to the session, indicating the role each participant would play (e.g., bidder, moderator, advertiser, guest etc.). With reference to FIG. 4, the details as entered can be reviewed and edited, if necessary. In one embodiment, a database of media vendors is maintained comprising the identity of media vendors that have participated in on-line auctions in the past.

As indicated above, groups of media vendors that fulfill the minimum requirements for the program may be pre-selected. In one embodiment, the pre-selected vendors also meet certain quality standards. To assist with quality assessment, score cards for vendors may be maintained, reflecting each vendor's past performance for specific buys. In some embodiments, the media vendors are rated by the media purchasers (i.e., the advertisers or the agencies). The media vendors would be more valuable from the standpoint of the advertisers or agencies if they are rated well. The amount of their usage of the system and various rankings would impact on the ratings.

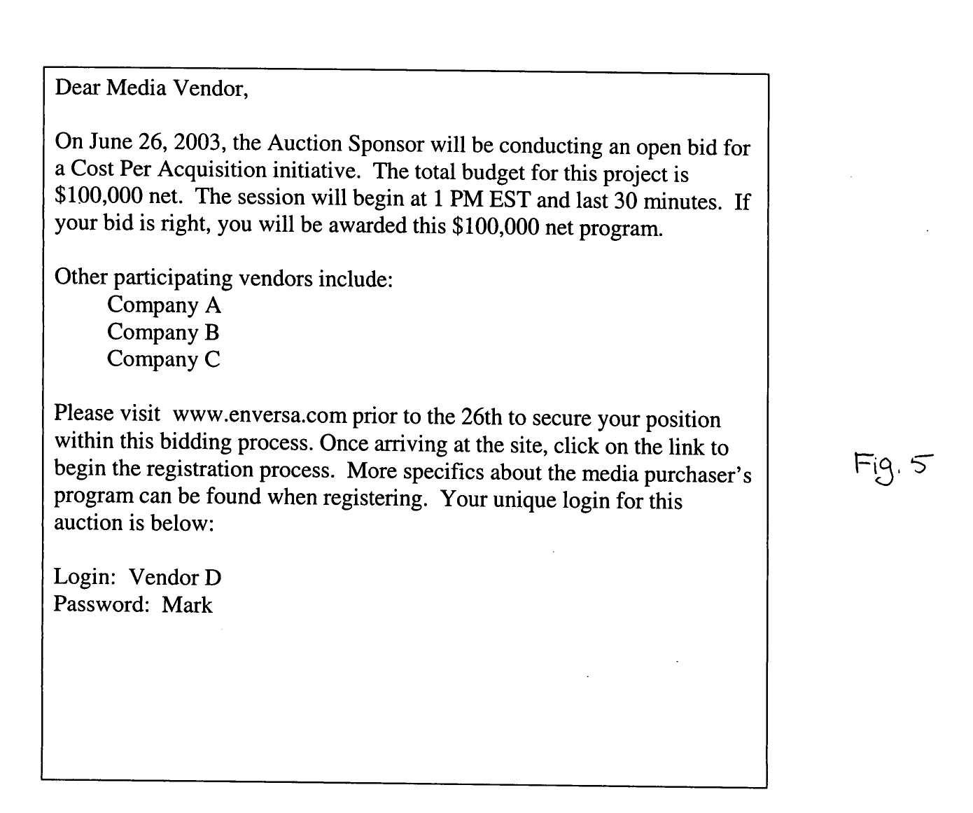

The pre-selected media vendors are sent an electronic invitation to the auction. In one embodiment, this occurs one week before the auction is to commence to allow the media vendor time to study the program under consideration, ask questions, and develop a bidding strategy. With reference to FIG. 5, an exemplary electronic invitation is shown. In a preferred embodiment the invitation process is automated; in particular, an invitation providing details regarding the session is automatically generated and sent via email (using, e.g., the interface shown in FIG. 3). The media vendor may accept or reject the invitation to participate via email, or by way of a Web site, as described in more detail below.

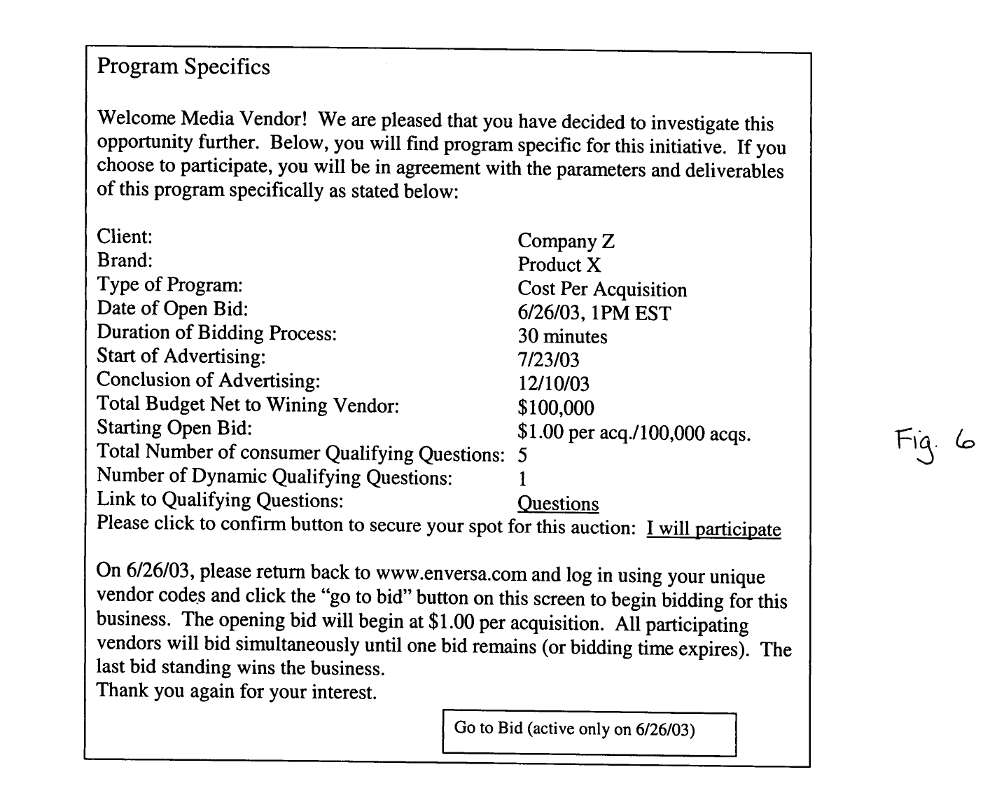

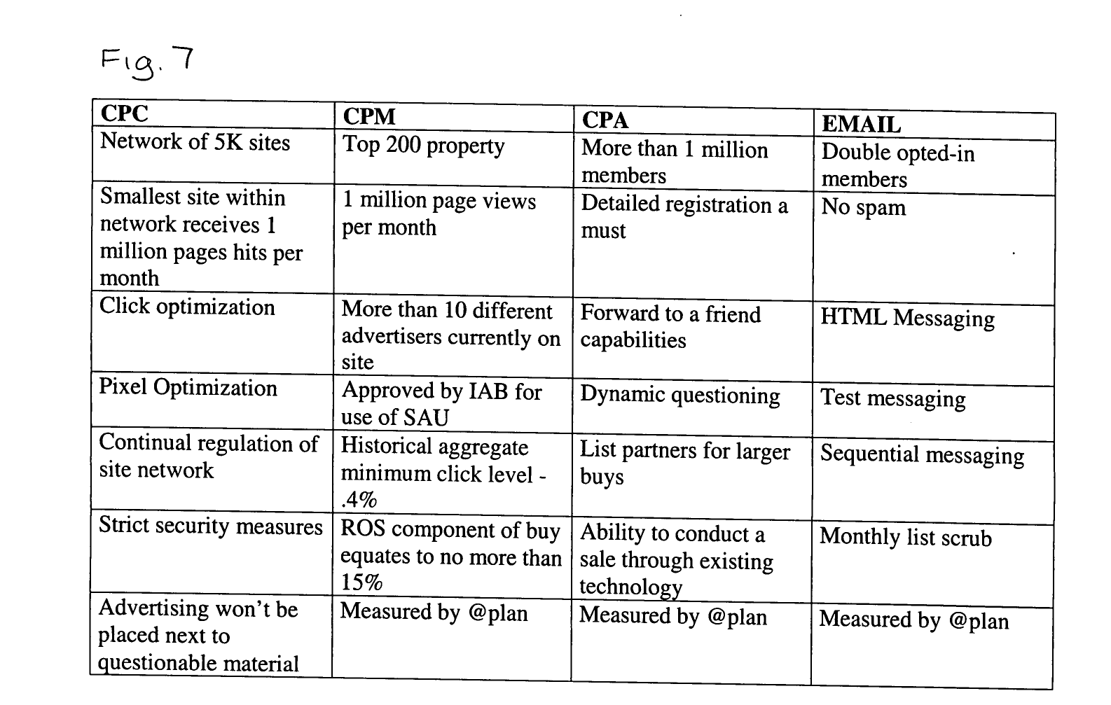

In one embodiment, upon receipt of the electronic invitation, the media vendor follows the URL in the invitation and, upon reaching the site associated with the URL, logs in using the unique user identifier and password provided in the invitation. Here,-the media vendor can view the specific program under consideration, an example of which is shown in FIG. 6. In particular, by way of example, the vendor can see information such as net revenue for the program, type of program, advertising window, and minimum inventory (e.g., acquisitions, clicks, impressions). After reviewing the program details, the vendor confirms its intent to participate in the auction. In some embodiments, rather than the vendor quality assessment being performed up front, the quality of the vendor is assessed at the time the vendor opts to participate in the auction. This assessment is performed by asking the vendor one or more qualifying questions. Exemplary subject areas covered by the questions are illustrated with reference to FIG. 7.

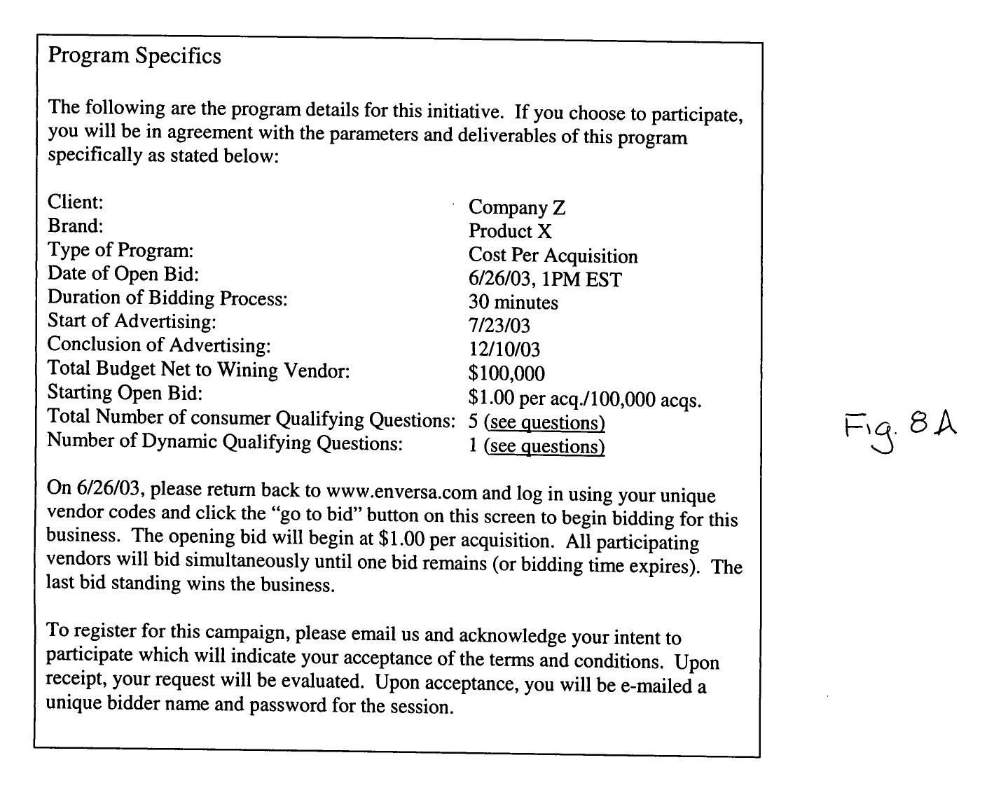

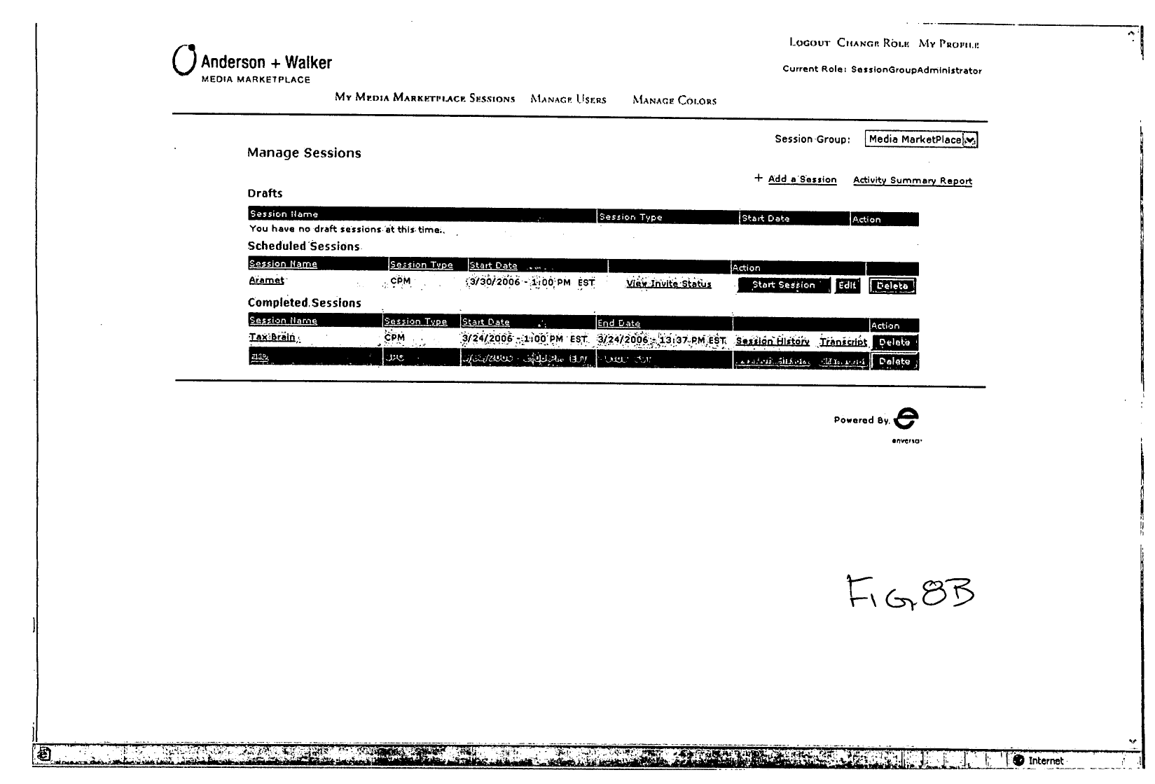

In still other embodiments, upcoming auctions are listed on a web site, in addition to or in lieu of sending invitations to select vendors. When the vendor clicks on an auction of interest listed on the web site, the program details are provided, as illustrated in FIG. 8A. In this embodiment, the vendor will be required to register and answer certain questions used to assess the quality of the vendor and its services. For example, the vendor may be asked questions regarding one or more of the criteria identified in FIG. 7. In this embodiment, the vendor is qualified based on the information submitted and, thereafter, is provided with an electronic message containing the vendor's unique identification number and password to be used for participating in the auction.

With reference to FIG. 8B, each participant can see the list of sessions in which it is scheduled to participate, as well as those sessions in which it previously participated.

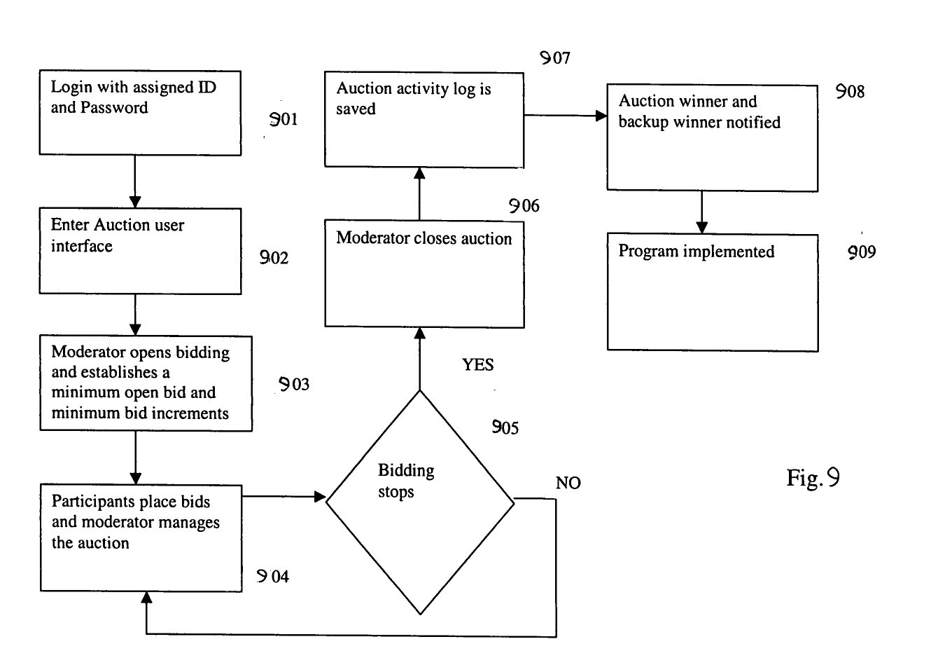

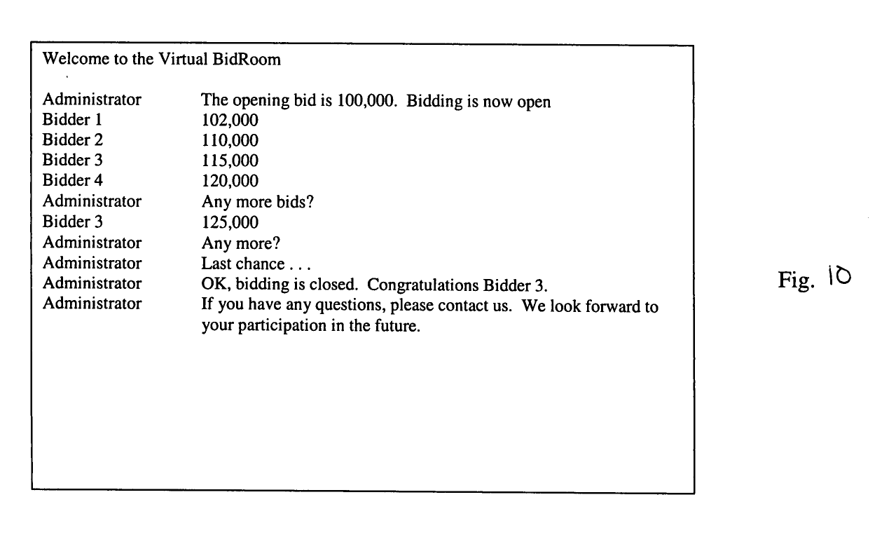

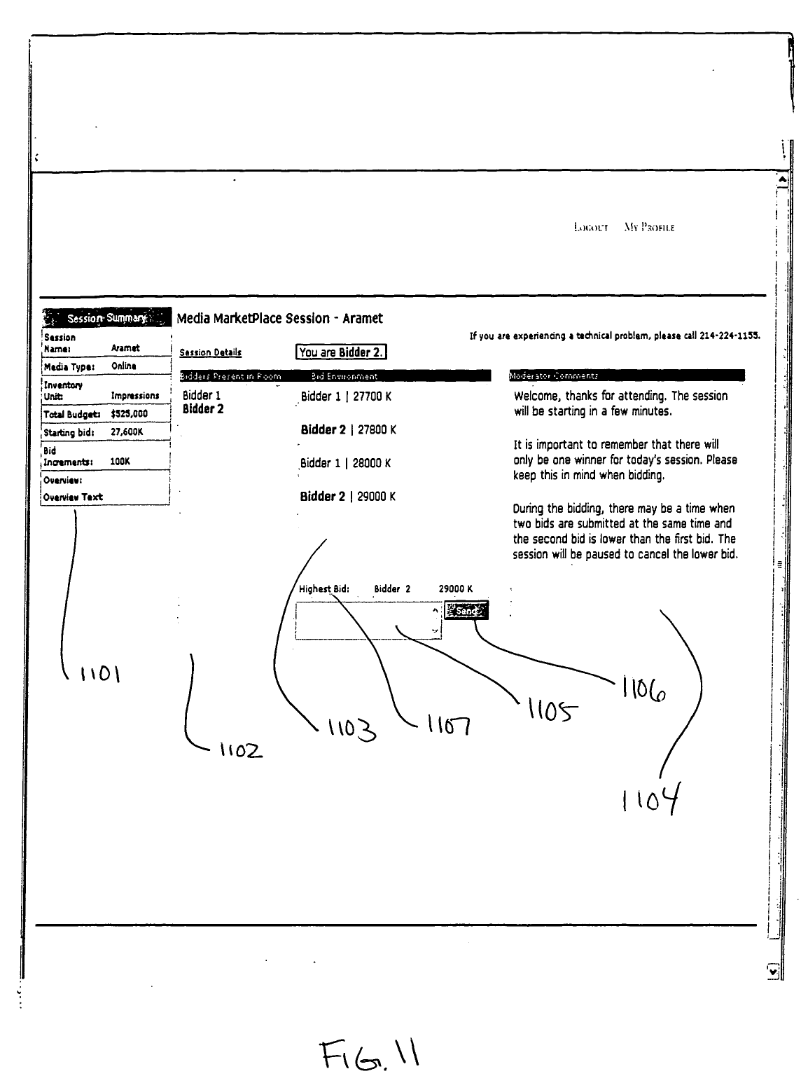

With reference to FIG. 9, an exemplary auction process is illustrated. Each vendor participating in the auction navigates to the site designated for the auction at the pre-determined date and time and logs in with its assigned identifier and password, in step 901. In step 902, the vendor enters the virtual bidding room. One exemplary virtual bidding room is illustrated with reference to FIG. 10. An alternative embodiment of the virtual bidding room of the present invention is described in more detail with respect to FIGS. 11, 12, and 13.

In a preferred embodiment, each vendor is informed of all the vendors taking part in the auction prior to the auction taking place. However, the vendors will not be identifiable to each other (although they will be identifiable to the advertising buyers and agencies) during the actual bidding process, as code names are used. The code names are unique to the vendor for a particular session (i.e., in a future session, the vendor would have a different code name), in the preferred embodiment.

Prior to the commencement of bidding, the moderator may review the rules of the auction. Thereafter, in step 903, the moderator opens bidding and may establish a minimum opening bid and minimum bidding increments. In accordance with the present invention, the dollar amount for the bid is fixed. The vendor's bids are inventory-based and increase over the course of the auction. For example, the bids increase as to how many acquisitions the vendor will provide for a $50,000 cost-per-acquisition (CPA) campaign. When the bid begins, each vendor enters its bid for the particular inventory requested, in step 904. When a bid is posted, each vendor will see the amount; however, only the moderator/auction sponsor and the media buyer will know which vendor submitted which bid. All viewers can see which bidder is in the lead and the value of the leading bid.

The moderator is preferably involved in the bidding to ensure an active process. When a time period (e.g., one minute) passes with no new bids, the moderator will notify vendors of the remaining time to ensure all final bids are submitted. When the bidding stops, in step 905, the moderator closes the auction, in step 906. The auction activity is recorded and, at the end of the session, saved in step 907; a transcript that reports on each bid posted during the session can be generated using this information. In a preferred embodiment, the last vendor to submit the highest inventory bid will win the business. In some embodiments, the session is set up, in advance, to declare more than one winner. The moderator announces the winner or winners and a backup winner in step 908. Thereafter, a contract between the media buyer and the winning media vendor is signed, and the program implemented, in step 909. In an alternative preferred embodiment, at least some of the activities performed by the moderator in connection with the auction are automated using software.

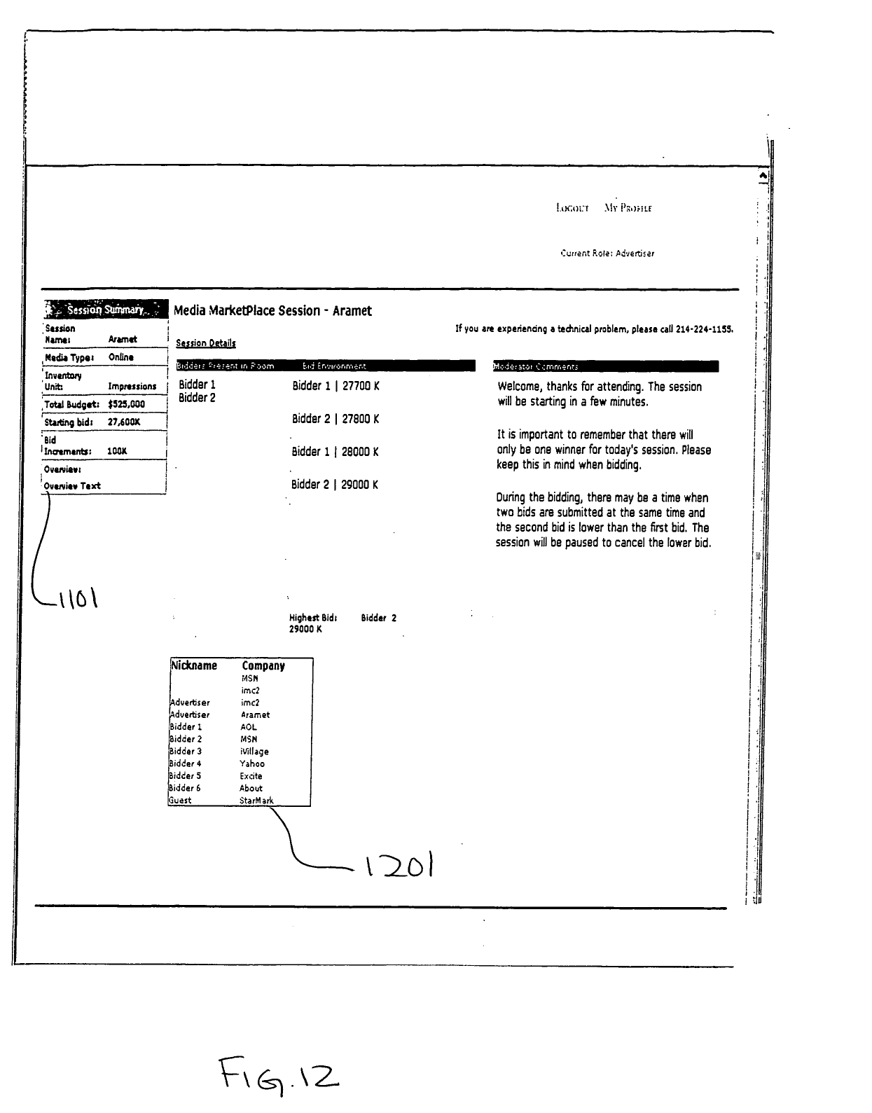

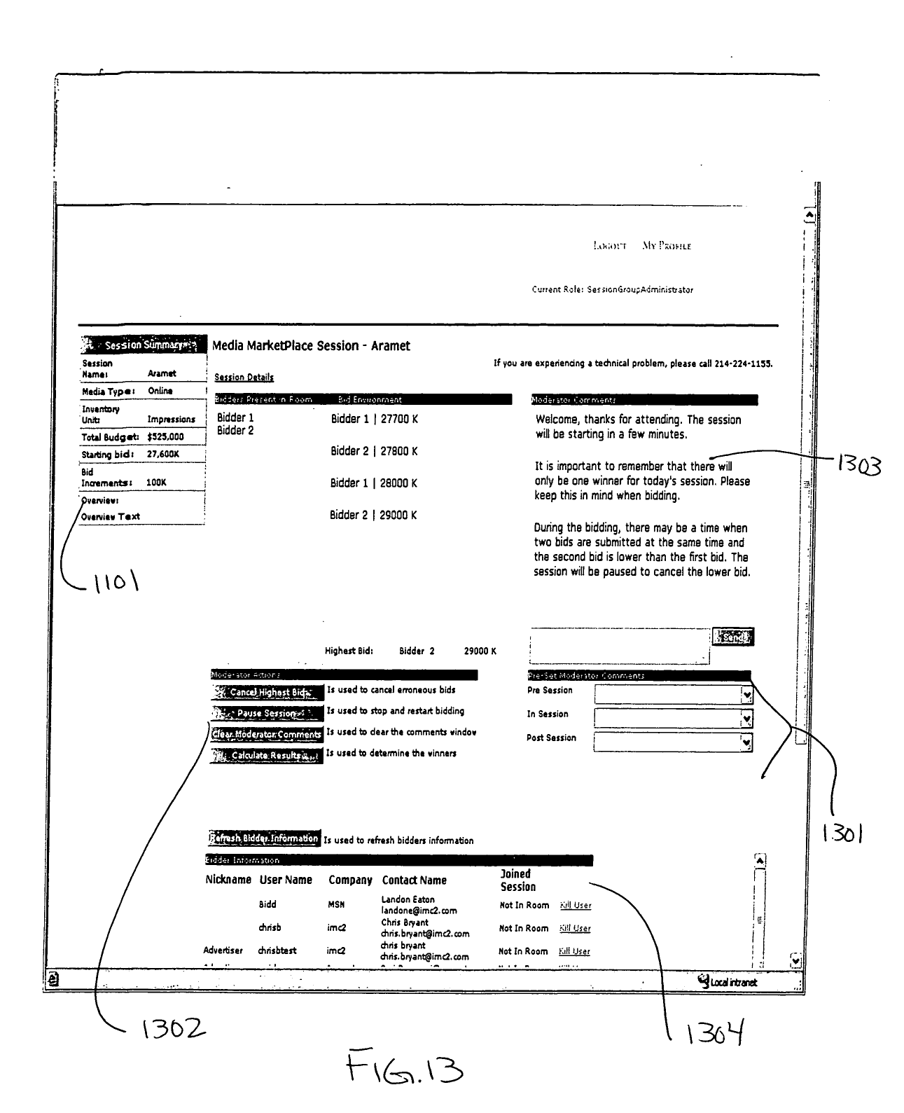

An alternative embodiment of the virtual bidding room is illustrated with reference to FIGS. 11, 12 and 13. In this embodiment, the interface of the virtual bidding room is different depending on whether the viewer is a bidder, an advertiser, or moderator. In addition, the level of authority afforded each participant varies depending on the role of the participant (e.g., administrator, moderator, bidder, guest, advertiser). FIG. 11 shows an exemplary virtual bidding room interface for a bidder; FIG. 12 shows an exemplary virtual bidding room interface for an advertiser; and FIG. 13 shows an exemplary virtual bidding room interface for the moderator. All views include session summary box 1101 (FIG. 11), which includes a link to more detailed information about the session. In this embodiment, the bidders' bids are displayed in a dialog box that is separate from the dialog box in which the moderator's comments are displayed.

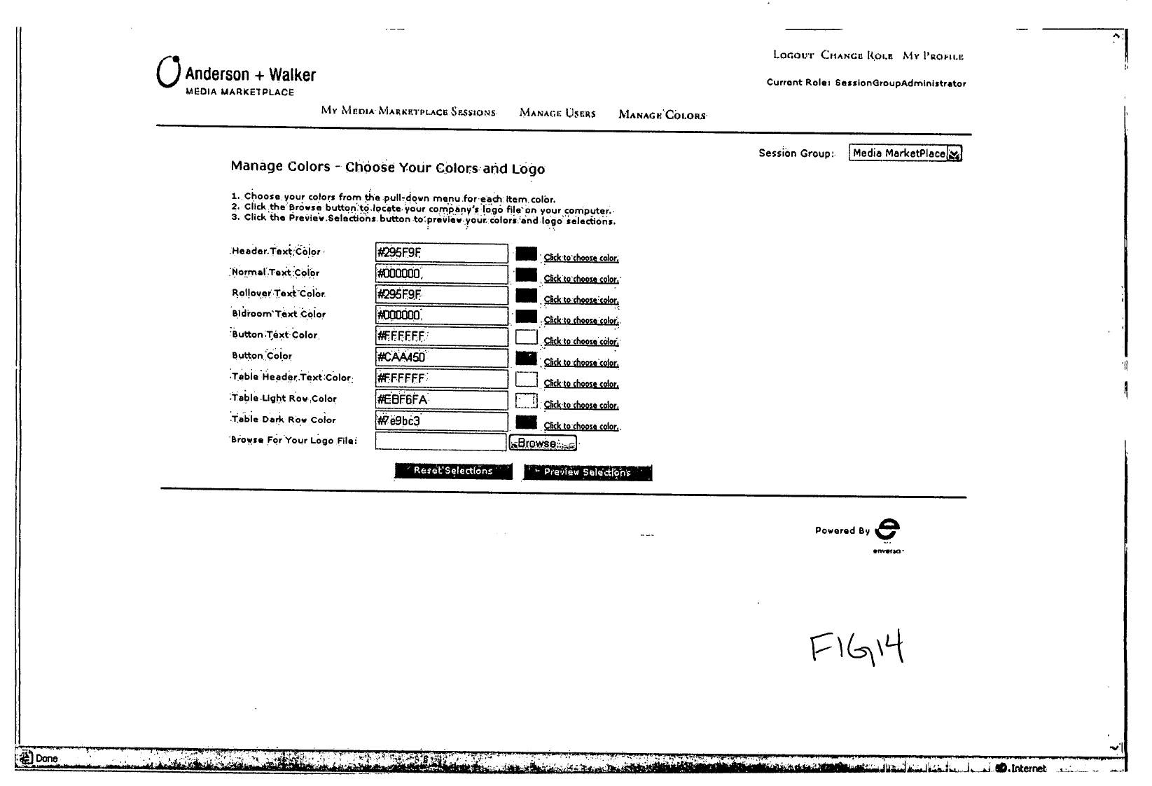

The virtual bidding room may be customized for the agency or advertiser, including the logo of the advertiser or agency, and colors or other graphics selected by an advertiser or agency, with reference to FIG. 14. The virtual bidding room may, as well, display or contain a link to the advertiser's or agency's legal information and terms/conditions of the session.

With reference to FIG. 11, the bidder view, in box 1102, the identity (generic) of each of the bidders present in the room is displayed. In box 1103, the bids posted by each bidder are displayed, identifying the bidder and the amount bid. The moderator's comments are displayed in box 1104. The bidder uses box 1105 to enter a bid amount and clicks the “send” button 1106 to post his bid. In a preferred embodiment, the software used to implement the virtual bidding room includes rules to limit the nature of the bids a bidder can submit by way of box 1105. For example, a bidder cannot enter any text using box 1105, only numerical information. This prevents bidders from interacting or negotiating. In addition, the bidder cannot enter a bid that is less than the highest bid currently submitted by a bidder (indicated in area 1107). Also, the bidder cannot bid in increments that are different from that set and indicated in the session summary in box 1101, or submit a bid that is lower than the starting bid indicated in the session summary in box 1101.

The advertiser view, shown in FIG. 12, is very similar to the bidder view (FIG. 11), except that the advertiser can determine, by way of box 1201, the identity of the bidders. In addition, the advertiser view does not include any mechanism for submitting bids.

With reference to FIG. 13, the moderator view is shown. Again, this view is similar to those shown in FIGS. 11 and 12 but, because the moderator controls the live auction process, additional functionality is provided. For example, with reference to area 1301, the moderator can select from pre-set moderator comments to be displayed to the participants, to avoid the moderator having to type in all of his comments, which would be unduly burdensome. Such pre-set comments may be categorized by pre-, in- and post-session comments. The pre-set comments may be customized in advance for a particular session. The moderator may also type in his own comments during the course a session. The moderator may use area 1302 to take certain actions with regard to a session. For example, the moderator may cancel erroneous bids, start, stop and temporarily disallow bidding, clear the comments window 1303, remove a bidder, and determine a winner. Box 1304 is used to provide the moderator with information regarding all participants in the session and, if necessary, terminate an individual's participation in the session.

In the preferred embodiment, multiple sessions can be conducted simultaneously, each with its own interface.

In some embodiments, the virtual bidding room can be branded, and in some instances administered and moderated, by a particular advertising agency or advertiser, rather than a third-party provider of on-line auction services. In this embodiment, the agency or advertiser is provided with software to include on their own systems, allowing the agency or advertiser may be customize its own interface, set up sessions, invite media vendors to participate, and conduct and moderate sessions.

In one embodiment, the various classes of media that can be included in the program may be specified, along with the minimum percentage allocations for each (e.g., some classes of media could be based on placement, ad unit size, or technology). In this embodiment, the winner of the bid is required to accept the total amount of inventory that results from the bidding process and split that total inventory between various media classes specified in the program details.

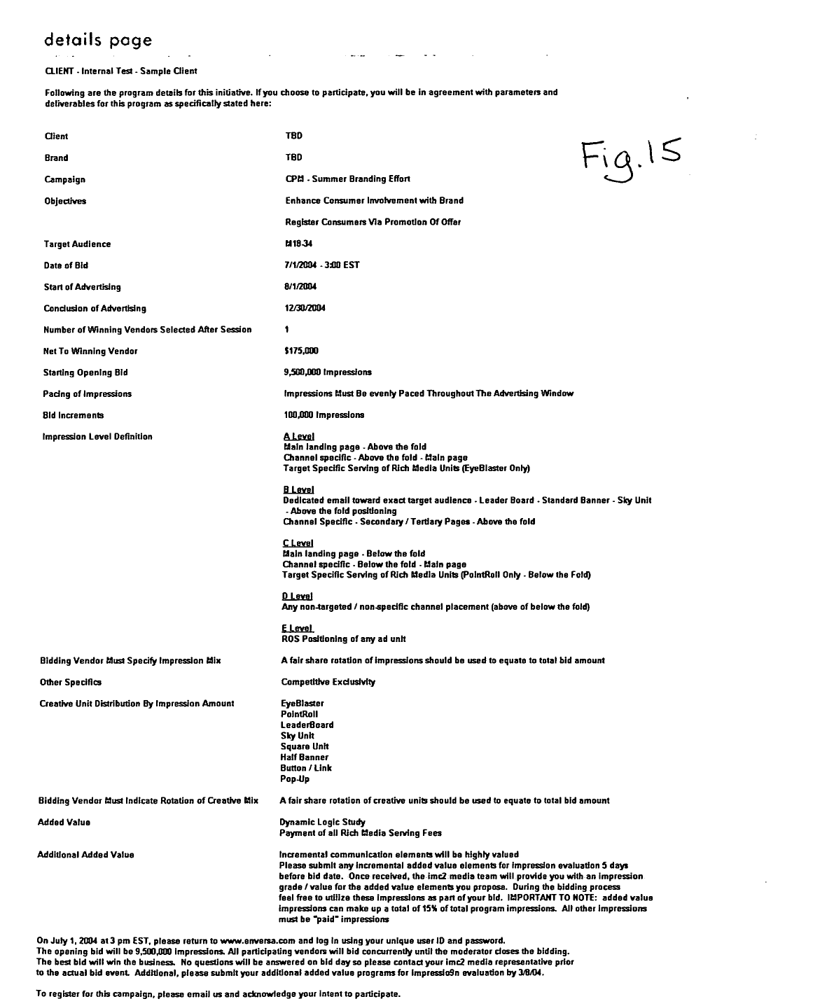

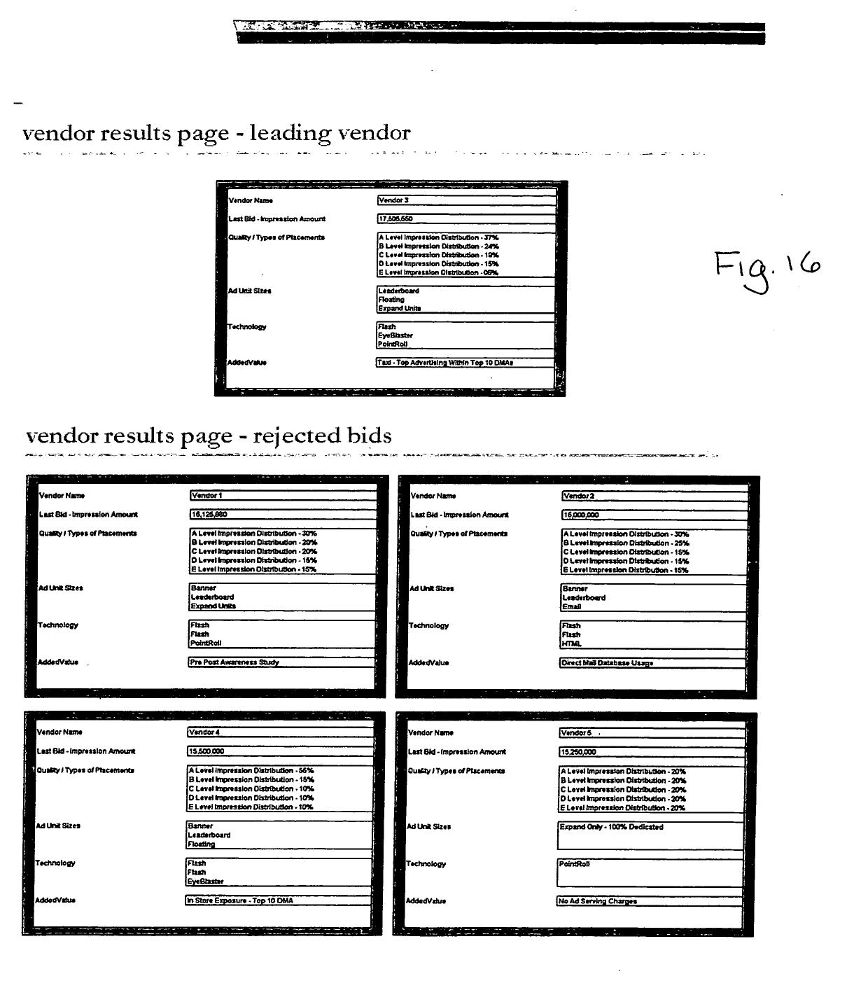

In another embodiment of the auction process, the bidders are required to submit a complete program, which would include various quantities of inventory, types of placement, ad unit size, and media technology. An example of the program details for this type of auction process is shown with reference to FIG. 15. All of the submissions are reviewed and the best one is chosen. The choice of the best submission may be subjective (i.e., the advertising purchase and/or the auction proprietor may review the bids and choose which one has the best mix of benefits). In an alternative embodiment, a formula may be used. By way of example, each proposal may be ranked from 1-100 based on the four criteria referenced above, with a particular weighting factor applied to each of the criteria. The reputation of the bidder may also be considered in determining the best bid. The chosen program is posted and the bidders in the auction are then invited to submit a subsequent round of proposed programs, in competition with the chosen program. This process may be repeated for several rounds, with winners of each round being recognized and posted, until the program that is most compelling to the advertising purchaser is presented. For example, once the programs submitted by the bidders do not improve with reference to a previous round, the last recognized bidder would be deemed the winner. FIG. 16 illustrates, in an exemplary fashion, the results of the auction carried out for the exemplary program details illustrated in FIG. 15.

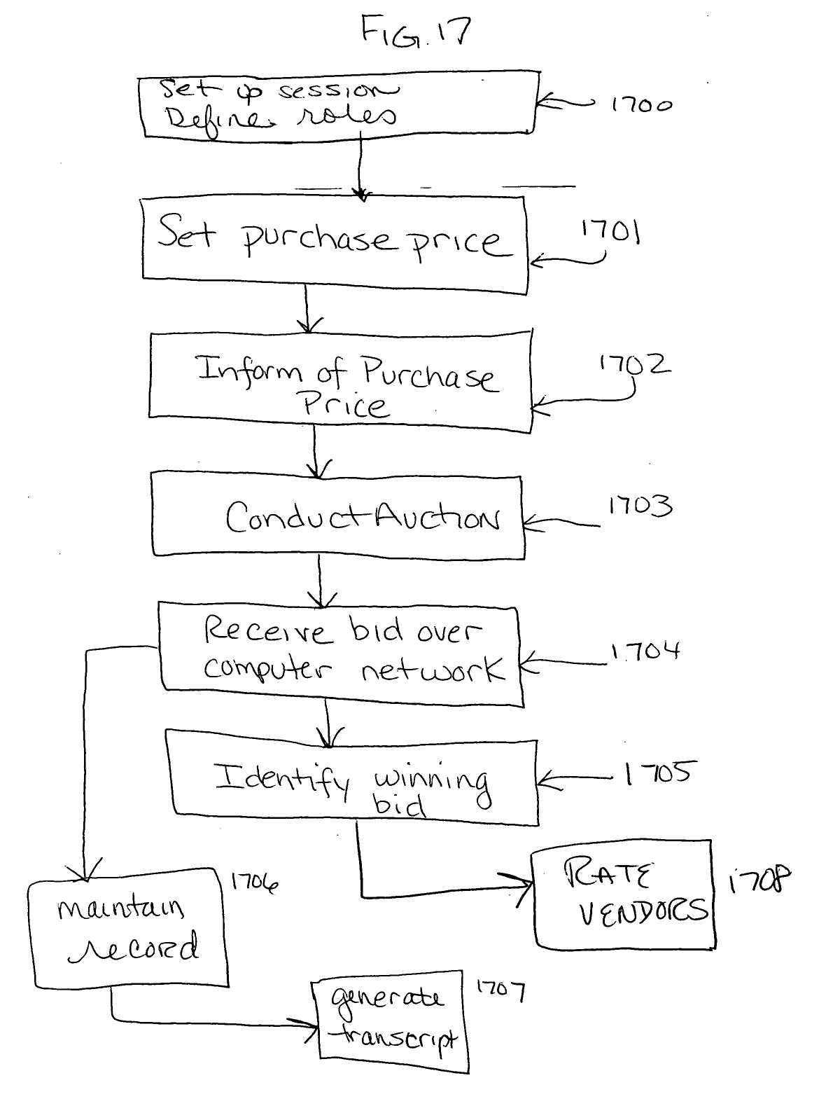

With reference to FIG. 17, a method for facilitating purchasing of advertising via an electronic auction is illustrated. In step, 1700, the auction session is set up; each participant in the auction has a defined role, which governs the authority he or she will have in connection with the auction. In step 1701, a purchase price comprising an amount that an advertising purchaser is willing to pay for advertising is set. In step 1702, two or more advertising sellers are informed of the purchase price. In step 1703, the electronic auction is conducted via a website interface maintained on a computer network. The auction is moderated by a moderator. In step 1704, at least one bid posted by at least one of the advertising sellers is received at the website, over the computer network. The bids comprise a quantity of advertising the advertising seller is willing to provide in exchange for the purchase price. In step 1705, a winning bid is identified based at least in part on the quantity of advertising each of the advertising sellers is willing to provide. In step 1706, a record of bids posted may be maintained and, in step 1707, a transcript generated therefrom. In step 1708, at some point after the conclusion of the auction, the media vendors may be rated by the advertisers or agencies.

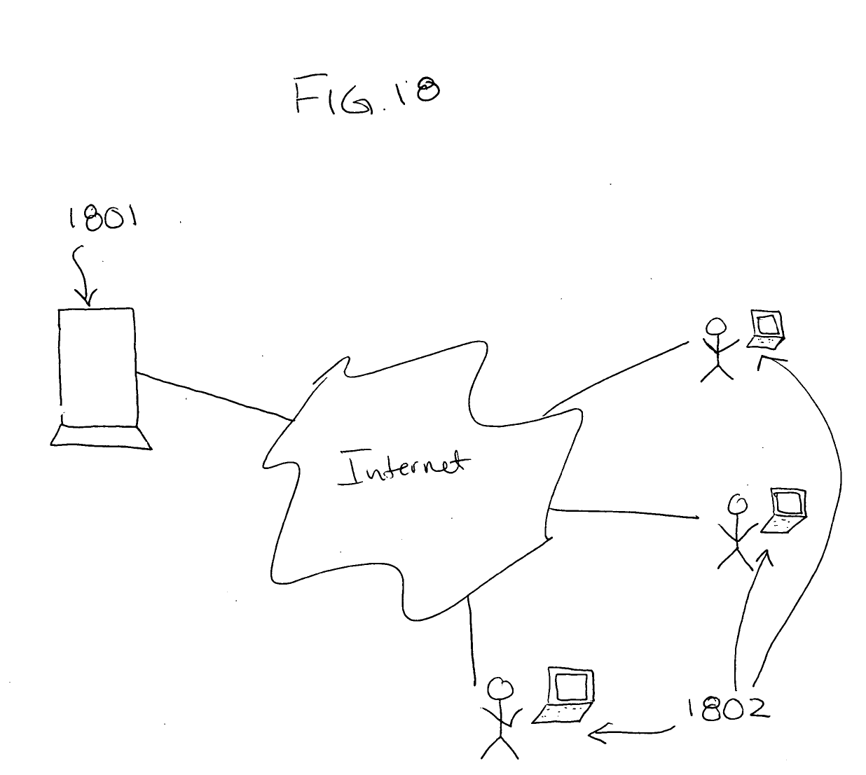

FIG. 18 illustrates an exemplary system for carrying out the present invention. Server(s) 1801 maintain the software that is used to support the on-line auction on the website. Server(s) 1801 may also be used for data storage to maintain, for example, the record of the auction activity, as well as information regarding participants in past and future auctions. Users 1802 (e.g., advertising sellers, advertising buyers, moderators, guests) may access the website over a communications network, such at the Internet. As referenced earlier, the servers may be owned/operated by a third party provider of on-line auction services; in this embodiment, the website may be branded by the third part service provider or an advertising agency. In other embodiments, the servers are owned/operated by the advertising agency itself.

In some embodiments, the advertisers or their agencies pay the third party on-line auction provider for the service. In other embodiments, the service is free to advertisers and the media vendors pay the fee.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A method for facilitating purchasing of advertising via an electronic auction comprising:
(A) setting a purchase price comprising an amount that an advertising purchaser is willing to pay for advertising;
(B) informing two or more advertising sellers of the purchase price;
(C) conducting the electronic auction via a website interface maintained on a computer network;
(D) moderating the electronic auction by a moderator;
(E) receiving at the website, over the computer network, at least one bid posted by at least one of the advertising sellers, wherein each of the bids comprises a quantity of advertising the advertising seller is willing to provide in exchange for the purchase price; and
(F) identifying a winning bid based at least in part on the quantity of advertising each of the advertising sellers is willing to provide,
wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area; and wherein all of the bids are viewable in the bid viewing area by all of the advertising sellers, by the advertising purchaser, and by the moderator upon being posted.

2. A method for facilitating purchasing of advertising via an electronic auction comprising:
(A) setting a purchase price comprising an amount that an advertising purchaser is willing to pay for advertising;
(B) informing two or more advertising sellers of the purchase price;
(C) conducting the electronic auction via a website interface maintained on a computer network;
(D) moderating the electronic auction by a moderator comprising, at least in part, an automated moderator;
(E) receiving at the website, over the computer network, at least one bid posted by at least one of the advertising sellers, wherein each of the bids comprises a quantity of advertising the advertising seller is willing to provide in exchange for the purchase price; and
(F) identifying a winning bid based at least in part on the quantity of advertising each of the advertising sellers is willing to provide,
wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area; and wherein all of the bids are viewable in the bid viewing area by all of the advertising sellers and by the advertising purchaser upon being posted.

3. The method of claim 1 wherein the advertising seller display view comprises a bid posting area.

4. The method of claim 2 wherein the advertising seller display view comprises a bid posting area.

5. The method of claim 3 wherein bids accepted by the website interface in the bid posting area are restricted to numerical data.

6. The method of claim 4 wherein bids accepted by the website interface in the bid posting area are restricted to numerical data.

7. The method of claim 5 wherein the bids accepted by the website interface in the bid posting area are restricted to numerical data of a value that is within a predetermined set of parameters.

8. The method of claim 6 wherein the bids accepted by the website interface in the bid posting area are restricted to numerical data of a value that is within a predetermined set of parameters.

9. The method of claim 1 wherein the moderator display view comprises a moderator comment area, wherein pre-set comments are made available to the moderator for posting in the moderator comment area.

10. The method of claim 1 wherein the moderator display view comprises a bid control area for controlling the bids, the controlling comprising canceling a bid.

11. The method of claim 1 wherein the moderator display view comprises an auction control area for controlling the auction, the controlling comprising at least one of pausing the auction, temporarily disallowing bidding, removing a bidder.

12. The method of claim 1 wherein none of the advertising sellers know an identity of any other of the advertising sellers during the electronic auction.

13. The method of claim 2 wherein none of the advertising sellers know an identity of any other of the advertising sellers during the electronic auction.

14. The method of claim 1 wherein the advertising purchaser display view comprises an advertising sellers identity box for revealing an identity of the advertising sellers.

15. The method of claim 2 wherein the advertising purchaser display view comprises an advertising sellers identity box for revealing an identity of the advertising sellers.

16. The method of claim 1 wherein the informing comprises automatically transmitting to the advertising seller an electronic message comprising an invitation to the electronic auction and wherein the advertising seller accepts or rejects the invitation electronically.

17. The method of claim 2 wherein the informing comprises automatically transmitting to the advertising seller an electronic message comprising an invitation to the electronic auction and wherein the advertising seller accepts or rejects the invitation electronically.

18. The method of claim 1 wherein a number of winning bids is predetermined in advance of the electronic auction and automatically processed at a conclusion of the electronic auction.

19. The method of claim 2 wherein a number of winning bids is predetermined in advance of the electronic auction and automatically processed at a conclusion of the electronic auction.

20. The method of claim 1 further comprising:
(G) maintaining a record of the bids received at the website and generating a transcript from the record.

21. The method of claim 2 further comprising:
(G) maintaining a record of the bids received at the website and generating a transcript from the record.

22. The method of claim 1 further comprising:
(G) rating, by the advertising purchasers, the advertising sellers participating in the electronic auction.

23. The method of claim 2 further comprising:
(G) rating, by the advertising purchasers, the advertising sellers participating in the electronic auction.

24. The method of claim 1 further comprising:
(G) assigning one or more levels of authority to participate in activities related to the electronic auction, wherein the levels of authority are based on a role of a participant in the electronic auction, the roles comprising at least one of an advertising purchaser role, an advertising seller role, and a moderator role.

25. The method of claim 2 further comprising:
(G) assigning one or more levels of authority to participate in activities related to the electronic auction, wherein the levels of authority are based on a role of a participant in the electronic auction, the roles comprising at least one of an advertising purchaser role and an advertising seller role.

26. The method of claim 1 wherein the electronic auction is conducted in an environment that is customized for the advertising purchaser.

27. The method of claim 2 wherein the electronic auction is conducted in an environment that is customized for the advertising purchaser.

28. The method of claim 1 wherein the electronic auction is conducted in an environment that is customized for an advertising agency.

29. The method of claim 2 wherein the electronic auction is conducted in an environment that is customized for an advertising agency.

30. A system for facilitating purchasing of advertising via an electronic auction comprising:
one or more servers that support a website maintained on a computer network for conducting the electronic auction, the conducting comprising:
(A) setting a purchase price comprising an amount that an advertising purchaser is willing to pay for advertising;
(B) informing two or more advertising sellers of the purchase price;
(C) moderating the electronic auction by a moderator;
(D) receiving at the website, over the computer network, at least one bid posted by at least one of the advertising sellers, wherein each of the bids comprises a quantity of advertising the advertising seller is willing to provide in exchange for the purchase price; and
(E) identifying a winning bid based at least in part on the quantity of advertising each of the advertising sellers is willing to provide,
wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area; and wherein all of the bids are viewable in the bid viewing area by all of the advertising sellers, by the advertising purchaser, and by the moderator upon being posted.

31. A system for facilitating purchasing of advertising via an electronic auction comprising:
one or more servers that support a website maintained on a computer network for conducting the electronic auction, the conducting comprising:
(A) setting a purchase price comprising an amount that an advertising purchaser is willing to pay for advertising;
(B) informing two or more advertising sellers of the purchase price;
(C) moderating the electronic auction by a moderator comprising, at least in part, an automated moderator;
(D) receiving at the website, over the computer network, at least one bid posted by at least one of the advertising sellers, wherein each of the bids comprises a quantity of advertising the advertising seller is willing to provide in exchange for the purchase price; and
(E) identifying a winning bid based at least in part on the quantity of advertising each of the advertising sellers is willing to provide,
wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area; and wherein all of the bids are viewable in the bid viewing area by all of the advertising sellers and by the advertising purchaser upon being posted.

32. The system of claim 30 wherein the advertising seller display view comprises a bid posting area.

33. The system of claim 31 wherein the advertising seller display view comprises a bid posting area.

34. The system of claim 32 wherein bids accepted by the website interface in the bid posting area are restricted to numerical data.

35. The system of claim 33 wherein bids accepted by the website interface in the bid posting area are restricted to numerical data.

36. The system of claim 34 wherein the bids accepted by the website interface in the bid posting area are restricted to numerical data of a value that is within a predetermined set of parameters.

37. The system of claim 35 wherein the bids accepted by the website interface in the bid posting area are restricted to numerical data of a value that is within a predetermined set of parameters.

38. The system of claim 30 wherein the moderator display view comprises a moderator comment area, wherein pre-set comments are made available to the moderator for posting in the moderator comment area.

39. The system of claim 30 wherein the moderator display view comprises a bid control area for controlling the bids, the controlling comprising canceling a bid.

40. The system of claim 30 wherein the moderator display view comprises an auction control area for controlling the auction, the controlling comprising at least one of pausing the auction, temporarily disallowing bidding, removing a bidder.

41. The method of claim 30 wherein none of the advertising sellers know an identity of any other of the advertising sellers during the electronic auction.

42. The method of claim 31 wherein none of the advertising sellers know an identity of any other of the advertising sellers during the electronic auction.

43. The system of claim 30 wherein the advertising purchaser display view comprises an advertising sellers identity box for revealing an identity of the advertising sellers.

44. The system of claim 31 wherein the advertising purchaser display view comprises an advertising sellers identity box for revealing an identity of the advertising sellers.

45. The system of claim 30 wherein the informing comprises automatically transmitting to the advertising seller an electronic message comprising an invitation to the electronic auction and wherein the advertising seller accepts or rejects the invitation electronically.

46. The system of claim 31 wherein the informing comprises automatically transmitting to the advertising seller an electronic message comprising an invitation to the electronic auction and wherein the advertising seller accepts or rejects the invitation electronically.

47. The system of claim 30 wherein a number of winning bids is predetermined in advance of the electronic auction and automatically processed at a conclusion of the electronic auction.

48. The system of claim 31 wherein a number of winning bids is predetermined in advance of the electronic auction and automatically processed at a conclusion of the electronic auction.

49. The system of claim 30 wherein the conducting further comprises:
(G) maintaining a record of the bids received at the website and generating a transcript from the record.

50. The system of claim 31 wherein the conducting further comprises:
(G) maintaining a record of the bids received at the website and generating a transcript from the record.

51. The system of claim 30 wherein the advertising purchasers rate the advertising sellers participating in the electronic auction

52. The system of claim 31 wherein the advertising purchasers rate the advertising sellers participating in the electronic auction.

53. The system of claim 30, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role, an advertising seller role, and a moderator role.

54. The system of claim 31, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role and an advertising seller role.

55. The system of claim 30 wherein the electronic auction is conducted in an environment that is customized for the advertising purchaser.

56. The system of claim 31 wherein the electronic auction is conducted in an environment that is customized for an advertising purchaser.

57. The system of claim 30 wherein the electronic auction is conducted in an environment that is customized for the advertising agency.

58. The system of claim 31 wherein the electronic auction is conducted in an environment that is customized for an advertising agency.

59. A method for facilitating purchasing of advertising via an electronic auction comprising:
(A) setting a purchase price comprising an amount that an advertising purchaser is willing to pay for advertising;
(B) informing two or more advertising sellers of the purchase price;
(C) conducting the electronic auction via a website interface maintained on a computer network;
(D) moderating the electronic auction by a moderator;
(E) receiving at the website, over the computer network, at least one bid posted by at least one of the advertising sellers, wherein each of the bids comprises a quantity of advertising the advertising seller is willing to provide in exchange for the purchase price and wherein each of the bids is restricted to numerical data and, optionally, to numerical data of a value that is within a predetermined set of parameters; and
(F) identifying a winning bid based at least in part on the quantity of advertising each of the advertising sellers is willing to provide,
wherein all of the bids are viewable by all participants in the auction upon being posted.

60. The method of claim 59 wherein the moderator comprises, at least in part, an automated moderator.

61. The method of claim 59 wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area.

62. The method of claim 60 wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area.

63. The method of claim 61 wherein the moderator display view comprises a moderator comment area, wherein pre-set comments are made available to the moderator for posting in the moderator comment area.

64. The method of claim 61 wherein the moderator display view comprises a bid control area for controlling the bids, the controlling comprising canceling a bid.

65. The method of claim 61 wherein the moderator display view comprises an auction control area for controlling the auction, the controlling comprising at least one of pausing the auction, temporarily disallowing bidding, removing a bidder.

66. The method of claim 59 wherein none of the advertising sellers know an identity of any other of the advertising sellers during the electronic auction.

67. The method of claim 60 wherein none of the advertising sellers know an identity of any other of the advertising sellers during the electronic auction.

68. The method of claim 59 wherein the advertising purchaser display view comprises an advertising sellers identity box for revealing an identity of the advertising sellers.

69. The method of claim 60 wherein the advertising purchaser display view comprises an advertising sellers identity box for revealing an identity of the advertising sellers.

70. The method of claim 59 wherein the informing comprises automatically transmitting to the advertising seller an electronic message comprising an invitation to the electronic auction and wherein the advertising seller accepts or rejects the invitation electronically.

71. The method of claim 60 wherein the informing comprises automatically transmitting to the advertising seller an electronic message comprising an invitation to the electronic auction and wherein the advertising seller accepts or rejects the invitation electronically.

72. The method of claim 59 wherein a number of winning bids is predetermined in advance of the electronic auction and automatically processed at a conclusion of the electronic auction.

73. The method of claim 60 wherein a number of winning bids is predetermined in advance of the electronic auction and automatically processed at a conclusion of the electronic auction.

74. The method of claim 59 further comprising:
(G) maintaining a record of the bids received at the website and generating a transcript from the record.

75. The method of claim 60 further comprising:
(G) maintaining a record of the bids received at the website and generating a transcript from the record.

76. The method of claim 59 further comprising:
(G) rating, by the advertising purchasers, the advertising sellers participating in the electronic auction.

77. The method of claim 60 further comprising:
(G) rating, by the advertising purchasers, the advertising sellers participating in the electronic auction.

78. The method of claim 59 further comprising:
(G) assigning one or more levels of authority to participate in activities related to the electronic auction, wherein the levels of authority are based on a role of a participant in the electronic auction, the roles comprising at least one of an advertising purchaser role, an advertising seller role, and a moderator role.

79. The method of claim 60 further comprising:
(G) assigning one or more levels of authority to participate in activities related to the electronic auction, wherein the levels of authority are based on a role of a participant in the electronic auction, the roles comprising at least one of an advertising purchaser role and an advertising seller role.

80. The method of claim 59 wherein the electronic auction is conducted in an environment that is customized for the advertising purchaser.

81. The method of claim 60 wherein the electronic auction is conducted in an environment that is customized for an advertising purchaser.

82. The method of claim 59 wherein the electronic auction is conducted in an environment that is customized for the advertising agency.

83. The method of claim 60 wherein the electronic auction is conducted in an environment that is customized for an advertising agency.

84. A system for facilitating purchasing of advertising via an electronic auction comprising:
one or more servers that support a website maintained on a computer network for conducting the electronic auction, the conducting comprising:
(A) setting a purchase price comprising an amount that an advertising purchaser is willing to pay for advertising;
(B) informing two or more advertising sellers of the purchase price;
(C) moderating the electronic auction by a moderator;
(D) receiving at the website, over the computer network, at least one bid posted by at least one of the advertising sellers, wherein each of the bids comprises a quantity of advertising the advertising seller is willing to provide in exchange for the purchase price and wherein each of the bids is restricted to numerical data and, optionally, to numerical data of a value that is within a predetermined set of parameters; and
(E) identifying a winning bid based at least in part on the quantity of advertising each of the advertising sellers is willing to provide,
wherein all of the bids are viewable by all participants in the auction upon being posted.

85. The system of claim 84 wherein the moderator comprises, at least in part, an automated moderator.

86. The system of claim 84 wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area.

87. The system of claim 85 wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area.

88. The system of claim 86 wherein the moderator display view comprises a moderator comment area, wherein pre-set comments are made available to the moderator for posting in the moderator comment area.

89. The system of claim 86 wherein the moderator display view comprises a bid control area for controlling the bids, the controlling comprising canceling a bid.

90. The system of claim 86 wherein the moderator display view comprises an auction control area for controlling the auction, the controlling comprising at least one of pausing the auction, temporarily disallowing bidding, removing a bidder.

91. The system of claim 84 wherein none of the advertising sellers know an identity of any other of the advertising sellers during the electronic auction.

92. The system of claim 85 wherein none of the advertising sellers know an identity of any other of the advertising sellers during the electronic auction.

93. The system of claim 84 wherein the advertising purchaser display view comprises an advertising sellers identity box for revealing an identity of the advertising sellers.

94. The system of claim 85 wherein the advertising purchaser display view comprises an advertising sellers identity box for revealing an identity of the advertising sellers.

95. The system of claim 84 wherein the informing comprises automatically transmitting to the advertising seller an electronic message comprising an invitation to the electronic auction and wherein the advertising seller accepts or rejects the invitation electronically.

96. The system of claim 85 wherein the informing comprises automatically transmitting to the advertising seller an electronic message comprising an invitation to the electronic auction and wherein the advertising seller accepts or rejects the invitation electronically.

97. The system of claim 84 wherein a number of winning bids is predetermined in advance of the electronic auction and automatically processed at a conclusion of the electronic auction.

98. The system of claim 85 wherein a number of winning bids is predetermined in advance of the electronic auction and automatically processed at a conclusion of the electronic auction.

99. The system of claim 84 wherein the conducting further comprises:
(G) maintaining a record of the bids received at the website and generating a transcript from the record.

100. The system of claim 85 wherein the conducting further comprises:
(G) maintaining a record of the bids received at the website and generating a transcript from the record.

101. The system of claim 84 wherein the advertising purchasers rate the advertising sellers participating in the electronic auction.

102. The system of claim 85 wherein the advertising purchasers rate the advertising sellers participating in the electronic auction.

103. The system of claim 84, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role, an advertising seller role, and a moderator role.

104. The system of claim 85, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role and an advertising seller role.

105. The system of claim 84 wherein the electronic auction is conducted in an environment that is customized for the advertising purchaser.

106. The system of claim 85 wherein the electronic auction is conducted in an environment that is customized for the advertising purchaser.

107. The system of claim 84 wherein the electronic auction is conducted in an environment that is customized for an advertising agency.

108. The system of claim 85 wherein the electronic auction is conducted in an environment that is customized for an advertising agency.

109. A method for facilitating purchasing of advertising via an electronic auction comprising:
(A) setting a purchase price comprising an amount that an advertising purchaser is willing to pay for advertising;
(B) informing two or more advertising sellers of the purchase price;
(C) conducting the electronic auction via a website interface maintained on a computer network;
(D) moderating the electronic auction by a moderator;
(E) receiving at the website, over the computer network, at least one bid posted by at least one of the advertising sellers, wherein each of the bids comprises a quantity of advertising the advertising seller is willing to provide in exchange for the purchase price; and
(F) identifying a winning bid based at least in part on the quantity of advertising each of the advertising sellers is willing to provide,
wherein all of the bids are viewable by all participants in the auction upon being posted and wherein the moderator is capable of controlling the bids.

110. The method of claim 109 wherein the moderator comprises, at least in part, an automated moderator.

111. The method of claim 109 wherein the controlling comprises canceling a bid.

112. The method of claim 109 wherein the controlling comprises at least one of pausing the auction, temporarily disallowing bidding, removing a bidder.

113. The method of claim 109 wherein each of the bids is restricted to numerical data and, optionally, to numerical data of a value that is within a predetermined set of parameters.

114. The method of claim 110 wherein each of the bids is restricted to numerical data and, optionally, to numerical data of a value that is within a predetermined set of parameters.

115. The method of claim 109 wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area.

116. The method of claim 110 wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area.

117. The method of claim 109 wherein the moderator display view comprises a moderator comment area, wherein pre-set comments are made available to the moderator for posting in the moderator comment area.

118. The method of claim 109 wherein none of the advertising sellers know an identity of any other of the advertising sellers during the electronic auction.

119. The method of claim 110 wherein none of the advertising sellers know an identity of any other of the advertising sellers during the electronic auction.

120. The method of claim 109 wherein the advertising purchaser display view comprises an advertising sellers identity box for revealing an identity of the advertising sellers.

121. The method of claim 110 wherein the advertising purchaser display view comprises an advertising sellers identity box for revealing an identity of the advertising sellers.

122. The method of claim 109 wherein the informing comprises automatically transmitting to the advertising seller an electronic message comprising an invitation to the electronic auction and wherein the advertising seller accepts or rejects the invitation electronically.

123. The method of claim 110 wherein the informing comprises automatically transmitting to the advertising seller an electronic message comprising an invitation to the electronic auction and wherein the advertising seller accepts or rejects the invitation electronically.

124. The method of claim 109 wherein a number of winning bids is predetermined in advance of the electronic auction and automatically processed at a conclusion of the electronic auction.

125. The method of claim 110 wherein a number of winning bids is predetermined in advance of the electronic auction and automatically processed at a conclusion of the electronic auction.

126. The method of claim 109 further comprising:
(G) maintaining a record of the bids received at the website and generating a transcript from the record.

127. The method of claim 110 further comprising:
(G) maintaining a record of the bids received at the website and generating a transcript from the record.

128. The method of claim 109 further comprising:
(G) rating, by the advertising purchasers, the advertising sellers participating in the electronic auction.

129. The method of claim 110 further comprising:
(G) rating, by the advertising purchasers, the advertising sellers participating in the electronic auction.

130. The method of claim 109 further comprising:
(G) assigning one or more levels of authority to participate in activities related to the electronic auction, wherein the levels of authority are based on a role of a participant in the electronic auction, the roles comprising at least one of an advertising purchaser role, an advertising seller role, and a moderator role.

131. The method of claim 110 further comprising:
(G) assigning one or more levels of authority to participate in activities related to the electronic auction, wherein the levels of authority are based on a role of a participant in the electronic auction, the roles comprising at least one of an advertising purchaser role and an advertising seller role.

132. The method of claim 109 wherein the electronic auction is conducted in an environment that is customized for the advertising purchaser.

133. The method of claim 110 wherein the electronic auction is conducted in an environment that is customized for the advertising purchaser.

134. The method of claim 109 wherein the electronic auction is conducted in an environment that is customized for an advertising agency.

135. The method of claim 110 wherein the electronic auction is conducted in an environment that is customized for an advertising agency.

136. A system for facilitating purchasing of advertising via an electronic auction comprising:
one or more servers that support a website maintained on a computer network for conducting the electronic auction, the conducting comprising:
(A) setting a purchase price comprising an amount that an advertising purchaser is willing to pay for advertising;
(B) informing two or more advertising sellers of the purchase price;
(C) moderating the electronic auction by a moderator;
(D) receiving at the website, over the computer network, at least one bid posted by at least one of the advertising sellers, wherein each of the bids comprises a quantity of advertising the advertising seller is willing to provide in exchange for the purchase price; and
(E) identifying a winning bid based at least in part on the quantity of advertising each of the advertising sellers is willing to provide,
wherein all of the bids are viewable by all participants in the auction upon being posted and wherein the moderator is capable of controlling the bids.

137. The system of claim 136 wherein the moderator comprises, at least in part, an automated moderator.

138. The system of claim 136 wherein the controlling comprises canceling a bid.

139. The system of claim 136 wherein the controlling comprises at least one of pausing the auction, temporarily disallowing bidding, removing a bidder.

140. The system of claim 136 wherein each of the bids is restricted to numerical data and, optionally, to numerical data of a value that is within a predetermined set of parameters.

141. The system of claim 137 wherein each of the bids is restricted to numerical data and, optionally, to numerical data of a value that is within a predetermined set of parameters.

142. The system of claim 136 wherein the website interface comprises at least three display views, the display views comprising a moderator display view, an advertising seller display view, and an advertising purchaser display view; wherein each of the three display views comprise two separate areas, one of the areas comprising a submitted bid viewing area and one of the areas comprising a moderator comment area.

143. The system of claim 137 wherein the website interface comprises at least two display views, the display views comprising an advertising seller display view and an advertising purchaser display view; wherein each of the display views comprise two separate areas, one of the areas comprising a submitted bid viewing area and one of the areas comprising a moderator comment area.

144. The system of claim 142 wherein the moderator display view comprises a moderator comment area, wherein pre-set comments are made available to the moderator for posting in the moderator comment area.

145. The system of claim 136 wherein none of the advertising sellers know an identity of any other of the advertising sellers during the electronic auction.

146. The system of claim 136 wherein none of the advertising sellers know an identity of any other of the advertising sellers during the electronic auction.

147. The system of claim 136 wherein the advertising purchaser display view comprises an advertising sellers identity box for revealing an identity of the advertising sellers.

148. The system of claim 137 wherein the advertising purchaser display view comprises an advertising sellers identity box for revealing an identity of the advertising sellers.

149. The system of claim 136 wherein the informing comprises automatically transmitting to the advertising seller an electronic message comprising an invitation to the electronic auction and wherein the advertising seller accepts or rejects the invitation electronically.

150. The system of claim 137 wherein the informing comprises automatically transmitting to the advertising seller an electronic message comprising an invitation to the electronic auction and wherein the advertising seller accepts or rejects the invitation electronically.

151. The system of claim 136 wherein a number of winning bids is predetermined in advance of the electronic auction and automatically processed at a conclusion of the electronic auction.

152. The system of claim 137 wherein a number of winning bids is predetermined in advance of the electronic auction and automatically processed at a conclusion of the electronic auction.

153. The system of claim 136 wherein the conducting further comprises:
(G) maintaining a record of the bids received at the website and generating a transcript from the record.

154. The system of claim 137 wherein the conducting further comprises:
(G) maintaining a record of the bids received at the website and generating a transcript from the record.

155. The method of claim 136 wherein the advertising purchasers rate the advertising sellers participating in the electronic auction.

156. The method of claim 137 wherein the advertising purchasers rate the advertising sellers participating in the electronic auction.

157. The system of claim 136, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role, an advertising seller role, and a moderator role.

158. The system of claim 137, wherein the servers are further used to set up the electronic auction, the setting up comprising:
(A) assigning one or more levels of authority to participate in activities related to the electronic auction, wherein the levels of authority are based on a role of a participant in the electronic auction, the roles comprising at least one of an advertising purchaser role and an advertising seller role.

159. The system of claim 136 wherein the electronic auction is conducted in an environment that is customized for the advertising purchaser.

160. The system of claim 137 wherein the electronic auction is conducted in an environment that is customized for the advertising purchaser.

161. The system of claim 136 wherein the electronic auction is conducted in an environment that is customized for an advertising agency.

162. The system of claim 137 wherein the electronic auction is conducted in an environment that is customized for an advertising agency.
